(19) United States
(12) Patent Application Publication
(10) Pub. No.: US 2014/0246487 A1
(43) Pub. Date: Sep. 4, 2014

(54) INFORMATION PROCESSING APPARATUS AND INFORMATION PROCESSING METHOD

(71) Applicant: TOSHIBA TEC KABUSHIKI KAISHA, Tokyo (JP)

(72) Inventors: Hidemi Mihara, Shizuoka-ken (JP); Hitoshi Iizaka, Shizuoka-ken (JP); Yuta Sasaki, Shizuoka-ken (JP)

(73) Assignee: TOSHIBA TEC KABUSHIKI KAISHA, Tokyo (JP)

(21) Appl. No.: 14/193,105

(22) Filed: Feb. 28, 2014

(30) Foreign Application Priority Data
Mar. 4, 2013 (JP) 2013-042226
Jun. 28, 2013 (JP) 2013-137417

(51) Int. Cl. G06Q 30/06

(52) U.S. Cl. CPC G06Q 30/0633
USPC 235/375

(57) ABSTRACT

In accordance with an embodiment, an information processing apparatus comprises an image capturing unit configured to capture an image of a commodity; a specification unit configured to specify a commodity from the information contained in the image captured by the image capturing unit; a first detection unit configured to detect flag information from the captured image; and a second detection unit configured to detect service information from the captured image in a case where the flag information is detected by the first detection unit, wherein the first detection unit switches a flag information detection according to the commodity specified by the specification unit.

### CROSS-REFERENCE TO RELATED APPLICATION

The present application is based upon and claims the benefit of priorities from Japanese Patent Application No. 2013-042226 filed on Mar. 4, 2013 and Japanese Patent Application No. 2013-137417 filed on Jun. 28, 2013, the entire contents of which are hereby incorporated by reference.

### FIELD

Embodiments described herein relate to an information processing apparatus and an information processing method.

### BACKGROUND

Conventionally, a technology has been proposed according to which an image capturing element such as a CCD (Charge Coupled Device) image sensor is used to captures an image of a barcode and a service label attached to a commodity and a commodity code or discount information is read from the captured image. Further, for a commodity attached with a service label, to prevent the omitted reading of the service label, a flag label (flag information) indicating the existence of the attached service label is adhered nearby a barcode. Then, a notice of the existence of the service label is given after the flag label is read, thereby preventing the omitted reading of the service label.

However, for the sake of a quick detection, typically, the flag label is a simple pattern which can be detected easily. Nonetheless, the pattern contained in the package of a commodity may be similar to that of a flag label, as a consequence, the pattern of the commodity may be detected as the flag label by mistake.

### BRIEF DESCRIPTION OF THE DRAWINGS

FIG. 1 is a diagram schematically illustrating an external configuration of a checkout system according to a first embodiment;

FIG. 2 is a diagram illustrating the configuration of a code reading apparatus according to the first embodiment;

FIG. 3 is a diagram illustrating an example of the relation between a commodity and an image capturing area of a camera;

FIG. 4 is a diagram illustrating an example of a commodity package; and

FIG. 5 is a flowchart illustrating a procedure of information reading processing executed by a code reading apparatus according to the first embodiment.

### DETAILED DESCRIPTION

In accordance with an embodiment, an information processing apparatus comprises an image capturing unit configured to capture an image of a commodity; a specification unit configured to specify a commodity from the information contained in the image captured by the image capturing unit; a first detection unit configured to detect flag information from the captured image; and a second detection unit configured to detect service information from the captured image in a case where the flag information is detected by the first detection unit, wherein the first detection unit switches a flag information detection according to the commodity specified by the specification unit.

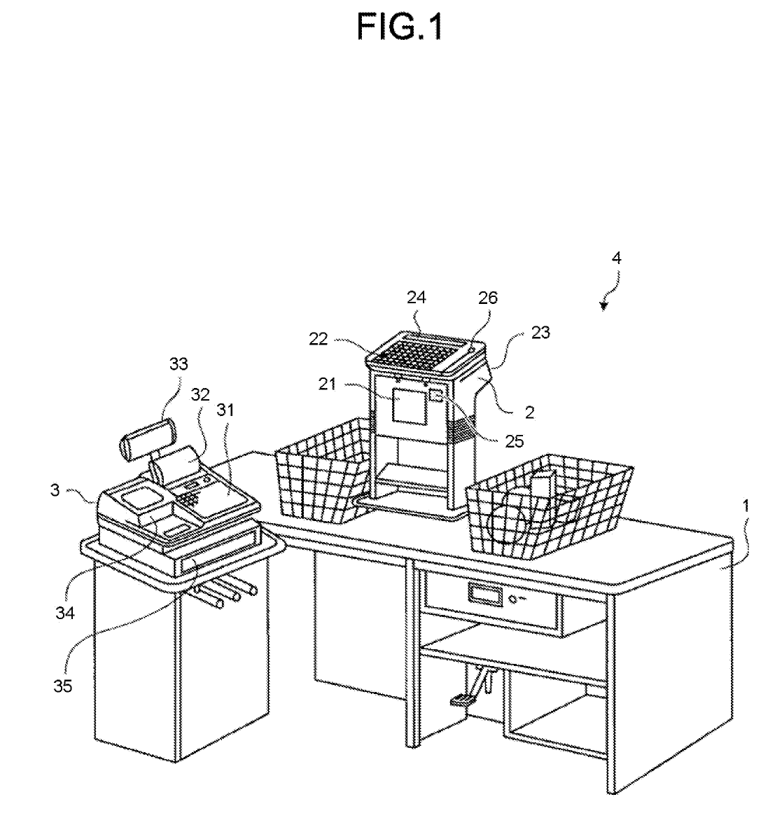

FIG. 1 is a diagram schematically illustrating the external configuration of a checkout line system 4 provided with a code reading apparatus 2 according to the present embodiment. As shown in FIG. 1, the checkout line system 4 comprises a sacker table 1 for placing a shopping basket in which commodities are placed, a code reading apparatus 2 which is vertically arranged in the approximate center of the sacker table 1, and a POS terminal 3 which is connected with the code reading apparatus 2 in a communicable manner through a transmission path (not shown).

The POS terminal 3 is a device for registering the sales of the commodities purchased by a customer. As shown in FIG. 1, the POS terminal 3 comprises a keyboard 31, a display for operator 32, a display for customer 33, a printer 34 for printing a receipt and the like, and a drawer 35 for storing cash and the like. A closing key necessary for the settlement of commodities is arranged on the keyboard 31. The POS terminal 3 has the same configuration and function as the standard POS terminal used in such a checkout line system.

The code reading apparatus 2 is an apparatus for reading the barcode attached to a commodity and outputting the commodity information (commodity code) contained in the barcode to the POS terminal 3. Herein, the commodity code is a commodity identifier by using which a commodity attached with a barcode can be specified.

As shown in FIG. 1, the code reading apparatus 2 comprises a reading window 21, a keyboard 22, a display for customer 23, a display for shop clerk 24, a buzzer 25 and a LED 26.

The keyboard 22 accepts inputs from various keys in a case of registering a commodity which cannot be registered using a barcode. The display for customer 23 displays a name, a price and the like of a registered commodity for a customer or shop clerk. The display for shop clerk 24 displays the name and the price of a registered commodity as well as other error message and the like for an operator such as a shop clerk.

A camera 20 (image capturing unit) is arranged inside the code reading apparatus 2 provided with the reading window 21. The camera 20 may also be, for example, an image capturing device using a CCD (Charge Coupled Device) or an image capturing device using other image capturing elements such as a CMOS (Complementary Metal Oxide Semiconductor) and the like. The camera 20 captures an image of a commodity held over an image capturing area opposite to the reading window 21.

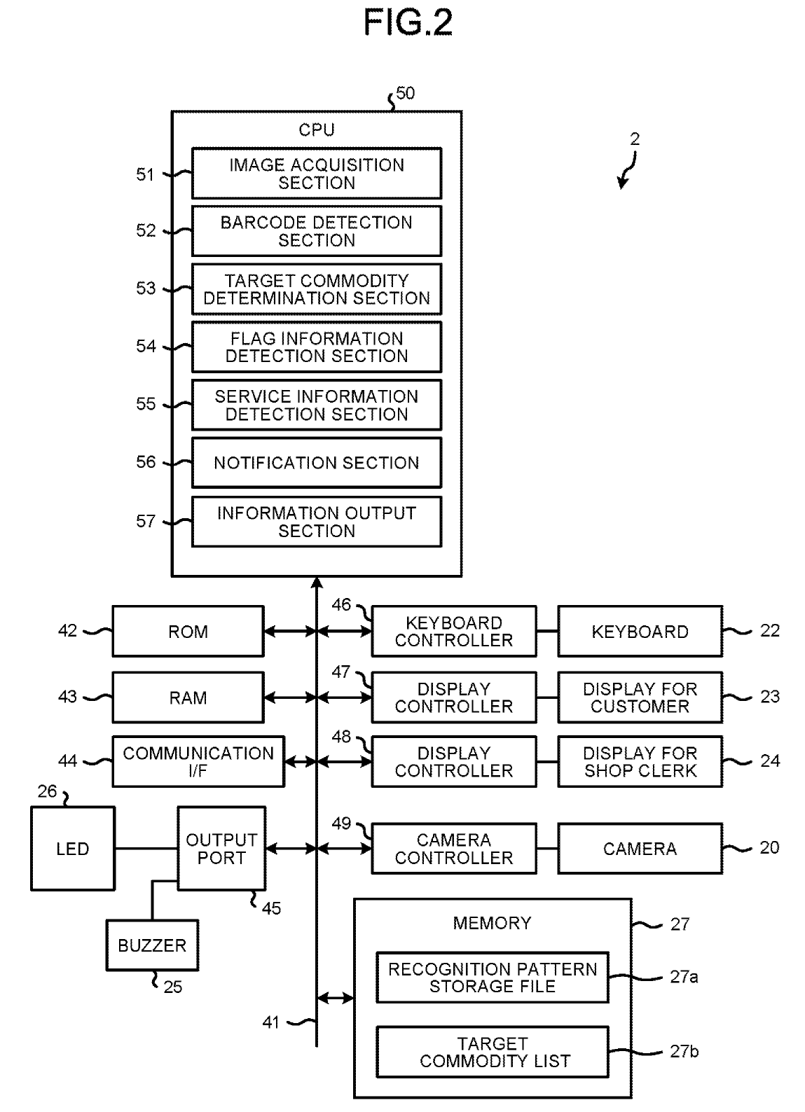

FIG. 2 is a diagram illustrating the configuration of the code reading apparatus 2 according to a first embodiment. The code reading apparatus 2 comprises a CPU 50, a ROM 42, a RAM 43, a communication I/F 44, an output port 45, a keyboard controller 46, display controllers 47 and 48, a camera controller 49 and a memory 27, which are connected with each other via a bus line 41 such as an address bus line or a data bus line.

The CPU 50 functions as a control section for controlling all operations of the code reading apparatus 2. The ROM 42 stores a program according to the present embodiment, other programs for controlling operations of the CPU 50, various target commodity lists and the like.

The RAM 43 functions as a work area when the CPU 50 develops various programs stored in the ROM 42. Further, the RAM 43 stores various data such as the image data captured by the camera 20.

The communication I/F 44 controls the data communication with the POS terminal 3 (refer to FIG. 1) which is connected with the communication I/F 44 via the bus line. The output port 45 outputs a drive signal to the buzzer 25 and the LED 26. The keyboard controller 46 acquires a key signal from the keyboard 22. The display controller 47 controls the data display on the display for customer 23. The display controller 48 controls the data display on the display for shop clerk 24. The camera controller 49 controls the image capturing operation of the camera 20.

The camera 20 captures an image of a code symbol (first symbol) such as a barcode or two-dimensional code attached to a commodity and a label (service label) representing a service such as a discount, a point granting and the like.

The memory 27, which is a nonvolatile memory such as a flash memory, stores various programs executed by the CPU 50 and various setting information of a recognition pattern storage file 27a, a target commodity list 27b and the like. The recognition pattern storage file 27a stores the flag information such as a flag label and a service label which will be described later, recognition pattern for carrying out a pattern recognition and information for carrying out character recognition. Further, the target commodity list 27b stores the commodity code of a commodity having a pattern similar to the design of the flag information such as a flag label which will be described later.

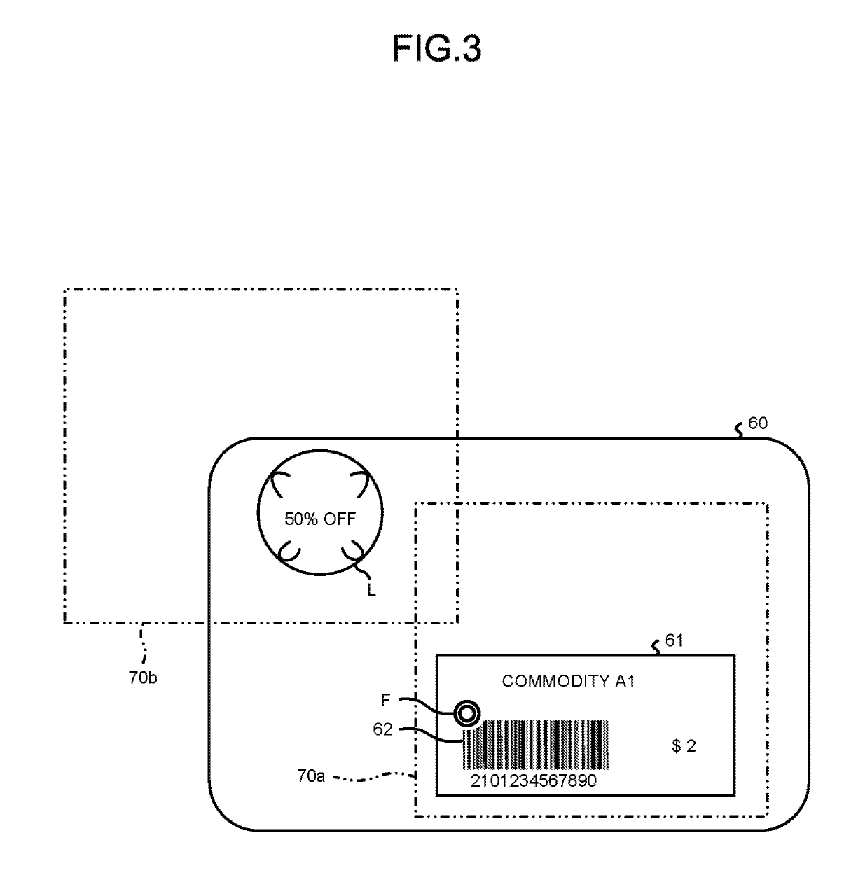

Next, a service label attached to a commodity for carrying out a discount sale of a commodity and a flag label attached to prevent the omitted reading of the service label are described below with reference to FIG. 3. Further, as to the preferred embodiments of a flag label and the flag label detection methods, existing technologies can be used, therefore the detailed description thereof is omitted.

FIG. 3 is a diagram illustrating an example of the relation between a commodity 60 and the image capturing area of the camera 20. The image capturing areas 70a and 70b surrounded by two dotted lines shown in FIG. 3 are areas which can be captured by the camera 20 in one frame. In addition to a barcode label 61, a discount label L serving as an example of a service label is also attached to the commodity 60 shown in FIG. 3.

The commodity name ‘commodity A1’ and the commodity price ‘$2’ of the commodity 60 and a barcode 62 are included in the barcode label 61. Information such as a commodity code is assembled into the barcode 62 as commodity information required to register the sales data of the commodity 60 using the POS terminal 3. Further, a commodity code ‘2101234567890’ assembled in the barcode 62 is printed under the barcode 62. The discount label L prints character information of ‘50% off’ representing the discount amount relating to the commodity 60.

In addition, the service label can be any label that is attached to the commodity 60 and prints an offered service during the sales registration of the commodity 60. The service label represents, with characters or a symbol, a given service offered to the commodity 60 specified with the barcode 62. In addition, the service label may also be a discount label printing the discount rate of the commodity 60 or a point addition label printing the number of points additionally granted to the customer purchasing the commodity 60 in addition to the points normally granted.

Further, a flag label F representing the attachment of the discount label L to the commodity 60 is attached nearby the barcode 62. When the flag label F is detected, the code reading apparatus 2 recognizes that the discount label L is attached to the commodity 60, then the camera 20 captures images repeatedly until the discount label L is read.

That is, as shown in FIG. 3, the barcode 62 and the discount label L, if attached to the commodity 60 at a distance from each other, cannot be captured in the same image capturing area. However, when the flag label F is detected, the code reading apparatus 2 notifies the operator of the existence of the attached discount label L, and the camera 20 captures images repeatedly until the discount label L is read. Then, when the position of the commodity 60 held over the reading window 21 is changed by the operator, the frame containing the image capturing area 70a in which the barcode 62 is covered and the image capturing area 70b in which the discount label L is covered is captured for many times, and the code reading apparatus 2 reads the discount label L.

In this way, even if the barcode 62 and the discount label L are attached at a distance from each other and cannot be captured by one shot, it can be prevented that the reading of the discount label L is omitted despite that the commodity 60 is a discount target commodity, and a sales registration is carried out without carrying out the discount processing.

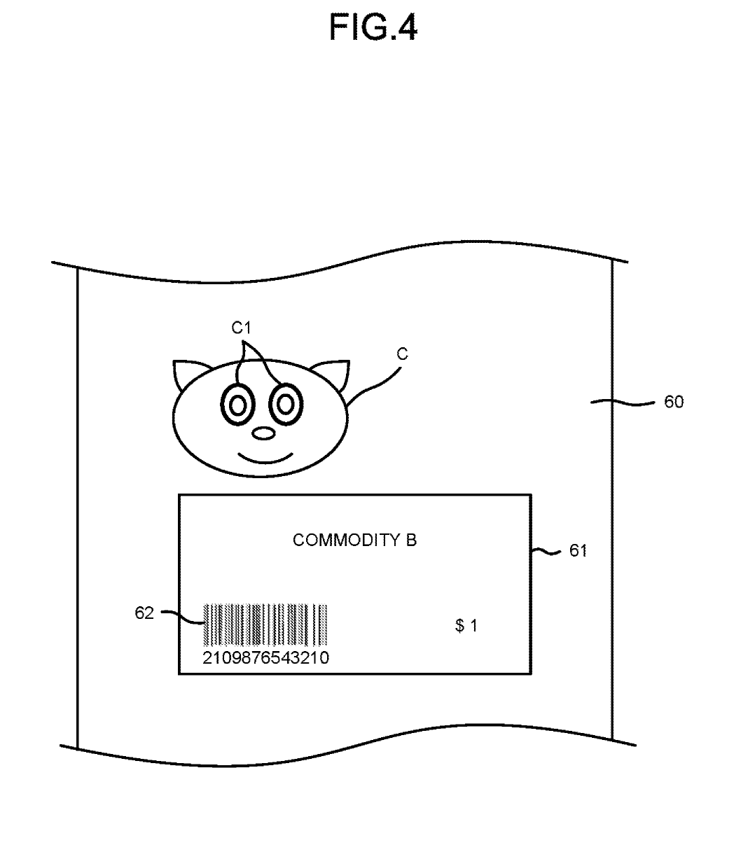

FIG. 4 is a diagram illustrating an example of a commodity package. For the sake of a quick detection, typically, the flag label F is a simple pattern which can be detected easily. Thus, in a plurality of commodities 60, there may be a commodity 60 having a pattern similar to the flag label F. For example, as shown in FIG. 4, the eyeballs C1 of the character C contained in the package of the commodity 60 is similar to the flag label F shown in FIG. 3. In this case, the eyeballs C1 may be detected as the flag label F by mistake.

Thus, in the present embodiment, the commodity code of the commodity 60 having a similar pattern with the flag label F is registered in the target commodity list 27b in advance. Then, when the code reading apparatus 2 reads the commodity code registered in the target commodity list 27b, the method for detecting the flag label F is switched to another one, thereby preventing the error detection of the pattern of the commodity 60 as the flag label F. Detailed operations are described below.

Next, the functional components of the code reading apparatus 2 realized through the program execution of the CPU 50 are described. The CPU 50 operates according to the program stored in the ROM 42 and expanded in the RAM 43 to function as an image acquisition section 51, a barcode detection section (specification unit), a target commodity determination section 53 (determination unit), a flag information detection section 54 (first detection unit), a service information detection section 55 (second detection unit) and a notification section 56 (notification unit) and an information output section 57.

The image acquisition section 5 outputs an ON-signal of image capturing to the camera controller 49 to start the image capturing operation of the camera 20. Further, after receiving an instruction from the service information detection section 55, the image acquisition section 51 acquires the image captured by the camera 20 in the image capturing area 70a or 70b and stores the acquired image in the image working area of the RAM 43.

The barcode detection section 52 detects the code symbol attached to the commodity from the image acquired by the image acquisition section 51. Further, the barcode detection section 52 reads a commodity code from the detected code symbol to specify the commodity attached with the code symbol.

Specifically, the barcode detection section 52 detects, from the acquired image, a two-dimensional code from a given finder pattern through a barcode detection based on a pattern matching technology. The barcode detection section 52 converts the code symbol detected using a specified decoding method into code information and reads code information corresponding to the code symbol. For example, in the example shown in FIG. 3, the barcode detection section 52 specifies a commodity by detecting the barcode 62 and reading the commodity code ‘2101234567890’ contained in the barcode 62.

The target commodity determination section 53 retrieves the commodity code read by the barcode detection section 52 from the target commodity list 27b and determines whether or not the commodity code is registered in the target commodity list 27b.

The flag information detection section 54 detects the image of flag information from the image acquired by the image acquisition section 51. Further, the flag information detection section 54 switches the flag information detection method according to the determination result of the target commodity determination section 53. Specifically, the flag information detection section 54 detects flag information using a first detection method if the target commodity determination section 53 determines that the commodity code is not registered in the target commodity list 27b. Further, the flag information detection section 54 detects flag information using a second detection method different from the first detection method if the target commodity determination section 53 determines that the commodity code is registered in the target commodity list 27b.

To prevent the pattern of the commodity 60 from being detected as flag information by mistake, the second detection method is stricter than the first detection method in the detection condition set for the detection of the flag label F. The detection condition for the detection of the flag label serving as flag information may be, for example, the aspect ratio of the flag label, the thickness of the lines (circle) constituting the flag label and the size of each circle, the color of the flag label, the size of the margin portion around the flag label and the relative position relation of the flag label and a barcode, and the like. In the second detection method, the detection conditions are sticker than those used in the first detection method. Further, the second detection method may also use other detection methods that are not used in the first detection method, but is not limited to the example described above. For example, the conventional face and eye recognition technology may be used to detect an area equivalent to a face or eyes from the pattern of the commodity 60, and a flag label is detected from other areas excluding the detected area.

Further, the flag information detection section 54 determines that the commodity 60 is attached with service information if an image of flag information is detected. Further, the flag information may be detected using an existing technology.

The service information detection section 55 detects, from the images sequentially acquired by the image acquisition section 51, the image of service information within a given period of time if the flag information detection section 54 determines that the commodity 60 is attached with service information. Further, if the image of the service information is detected, the service information detection section 55 reads service content information representing the content of the service indicated by the service information.

Specifically, the service information detection section 55 detects the image area of a service label serving as service information using information which is preset in the recognition pattern storage file 27a to represent the graphic characteristics such as the frame border and the shape of a service flag. Then, the service information detection section 55 reads the service content information such as a discount amount, discount rate and the like represented by a service label by carrying out a character recognition processing or a pattern recognition processing on the image area of the detected service label using an OCR (Optical Character Reader). For example, in the example shown in FIG. 3, the service information detection section 55 recognizes the character (e.g. 50% off) recorded on the discount label L and reads service content information representing a discount of 50%.

In a case where the flag information detection section 54 determines that there is a service label serving as service information attached to the commodity 60, the notification section 56 displays a first message which indicates that a service label is attached to the commodity 60 or instructs to read the service label on the display for shop clerk 24.

For example, if it is determined that the commodity 60 is attached with a service label, the notification section 56 enables the buzzer 25 to sound and controls the display controller 48 to display the first message such as ‘scan the service label please’ on the display for shop clerk 24, thereby notifying the operator of the adhesion of a service label on the commodity 60 to prevent the omitted reading of the service label.

Further, if no service label serving as service information is detected by the service information detection section 55 within a given period of time, the notification section 56 displays a second message such as ‘no service label?’ on the display for shop clerk 24, thereby urging the operator to confirm whether or not there is an attached service label. Further, the notification may also be carried out through a sound output, but is not limited to the aforementioned example. Further, the notification section 56 may also turn on or turn off the LED 26 to give a notification.

The information output section 57 outputs the code information read by the barcode detection section 52 to the POS terminal 3 via the communication I/F 44. Further, if the service information detection section 55 reads service content information, the information output section 57 outputs the read service content information to the POS terminal 3 together with the code information.

The POS terminal 3 receives the code information output by the information output section 57 of the code reading apparatus 2 and registers the sales of the commodity 60 using the received code information. Further, after receiving the service content information and the code information, the POS terminal 3 endows the commodity 60 with a service corresponding to the service content information and then registers the sales of the commodity 60.

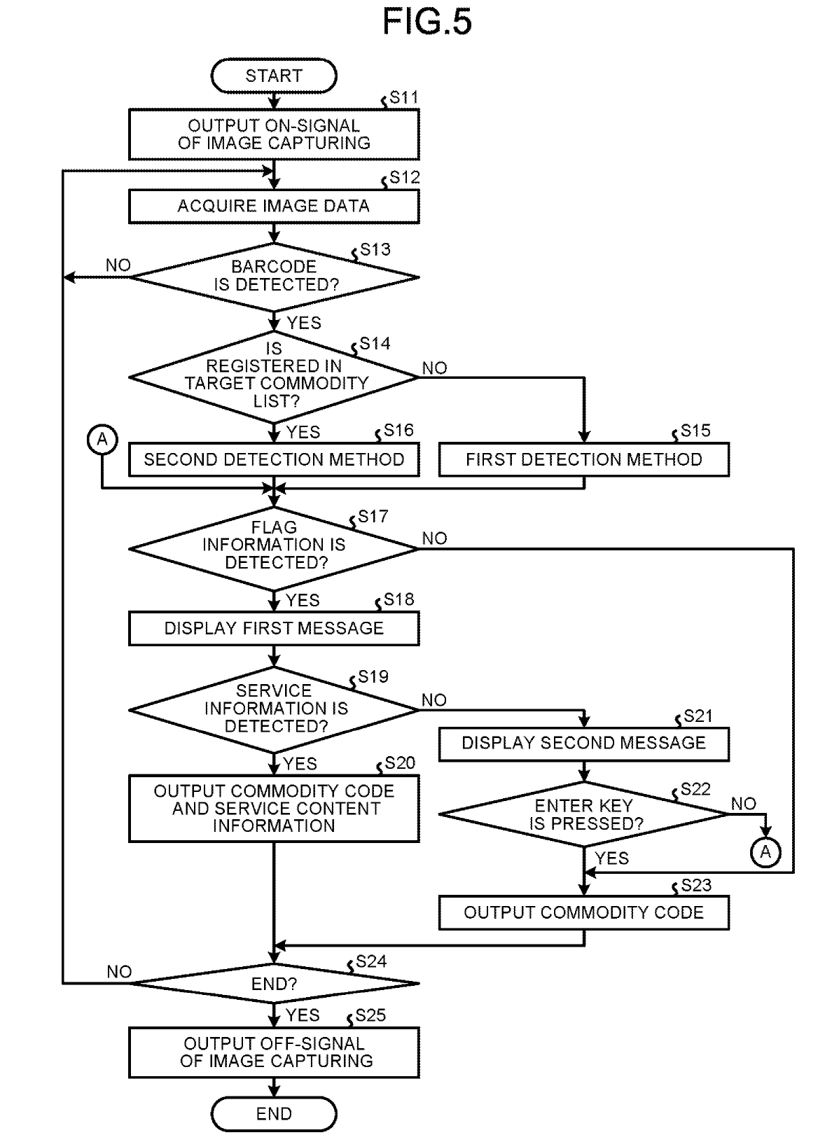

Next, the procedure of the information reading processing executed by the code reading apparatus 2 according to the present embodiment is described with reference to FIG. 5 which illustrates the procedure of the information reading processing executed by the code reading apparatus 2.

When receiving a scan starting instruction from the POS terminal 3, the image acquisition section 51 of the code reading apparatus 2 outputs an ON-signal of image capturing to the camera controller 49 to start the image capturing of the camera 20 (ACT S11). The image acquisition section 51 acquires the image data of the image captured by the camera 20 to the image working area of the RAM 43 (ACT S12).

The barcode detection section 52 determines whether or not a barcode image is detected in the acquired image (ACT S13). If no barcode image is detected (NO in ACT S13), the image acquisition section 51 continues the image capturing of the camera 20 (ACT S12). If a barcode image is detected (YES in ACT S13), the barcode detection section 52 reads code information corresponding to the detected barcode.

Next, the target commodity determination section 53 determines whether or not the commodity code read in ACT S13 is registered in the target commodity list 27b (ACT S14). Herein, if the target commodity determination section 53 determines that the commodity code is not registered in the target commodity list 27b (NO in ACT S14), the flag information detection section 54 detects the image of flag information from the acquired image using the first detection method (ACT S15). Further, if the target commodity determination section 53 determines that the commodity code is registered in the target commodity list 27b (YES in ACT S14), the flag information detection section 54 detects the image of flag information from the acquired image using the second detection method (ACT S16).

The flag information detection section 54 determines whether or not the image of flag information is detected in ACT S15 or ACT S16 (ACT S17). Herein, if it is determined that the image of flag information is not detected (NO in ACT S17), the flow proceeds to ACT S23.

On the other hand, in ACT S17, the flag information detection section 54 determines that the commodity 60 is attached with service information if the image of flag information is detected (YES in ACT S17). Subsequently, the notification section 56 displays the first message which indicates that service information is attached to the commodity 60 or instructs to read the service information on the display for shop clerk 24 (ACT S18).

Next, the service information detection section 55 detects a service information image from the sequentially acquired images and determines whether or not service information is detected within a pre-determined time (ACT S19). Herein, if service information is detected within the given time (YES in ACT S19), the information output section 57 outputs the commodity code read in ACT S13 and the service content information read from service information using an OCR and the like to the POS terminal 3 (ACT S20).

On the other hand, in ACT S19, if a service label serving as service information is not detected within the given time (NO in ACT S19), the notification section 56 enables the display for shop clerk 24 to display the second message such as ‘no discount label?’, thereby urging the operator to confirm whether or not there is an attached service label (ACT S21).

If the operator confirms that no service label is attached to the commodity 60 and presses an Enter key on the keyboard 22 (YES in ACT S22), the information output section 57 outputs the commodity code read in ACT S13 to the POS terminal 3 (ACT S23). On the other hand, if the Enter key is not pressed in ACT S22 (NO in ACT S22), the flow returns to ACT S17.

After the processing in ACT S20 or ACT S23 is carried out, the code reading apparatus 2 determines whether or not an instruction indicating that the sales registration processing is ended and instructing to end the barcode reading processing is received from the POS terminal 3 (ACT S24). If the instruction instructing to end the barcode reading processing is not received (NO in ACT S24), the flow returns to ACT S12 to continue the following processing. If the instruction instructing to end the barcode reading processing is received (YES in ACT S24), the code reading apparatus 2 outputs an OFF-signal of image capturing to the camera controller 49 (ACT S25) to end the image capturing of the camera 20.

As stated above, according to the present embodiment, the commodity code of the commodity 60 having a pattern similar to flag information is registered in the target commodity list 27b, and the detection method of flag information is switched to detect the flag information if the commodity code registered in the target commodity list 27b is read. Thus, in the case of the commodity 60 having a mark similar to flag information, the flag information can be detected using a detection method different from that used for detecting an ordinary commodity not having the mark or using a stricter detection condition, which reduces the possibility of an error detection of the flag information.

While certain embodiments have been described, these embodiments have been presented by way of example only, and are not intended to limit the scope of the present invention. Indeed, the novel embodiments may be embodied in a variety of other forms; furthermore, various omissions, substitutions, variations, supplementations and combinations thereof may be devised without departing from the spirit of the present invention. The accompanying claims and their equivalents are intended to cover such forms and modifications as would fall within the scope and spirit of the present invention.

For example, the commodity 60 attached with one service label is exemplarily described in the aforementioned embodiments; however, the commodity 60 may be attached with a plurality of service labels. In this case, the information output section 57 outputs the plurality of pieces of service information read from each service label to the POS terminal 3 together with code information.

The service information such as price-cut or discount and the barcode are not limited to be printed on the label. As another example, the service information and the barcode may also be directly recorded or printed on the commodity 60. In addition, the flag information is not limited to be printed on the label. As another example, the service information and the barcode may also be directly recorded or printed on the commodity 60. Double circle are described in the aforementioned embodiment as a flag label F; however, the present invention is not limited to this, the flag label F may also be a mark or pattern such as a triangle, quadrangle, a check mark and the like, or characters.

Further, in the aforementioned embodiments, a commodity is specified by reading the code symbol (barcode) attached to the commodity, however, the method of specifying a commodity is not limited to this. For example, the commodity may also be specified using a well-known object recognition technology which specifies (recognizes) an object according to the feature amount obtained from the appearance of the object. In this case, the specification unit of the information processing apparatus extracts, from an image captured by the camera 20, appearance feature (shape, tone, concave-convex situation and the like) of the commodity serving as an image capturing subject. Then, the specification unit of the information processing apparatus compares the extracted feature amount with the pre-prepared feature amount (data for comparison) of a standard commodity to specify (recognize) the commodity serving as an image capturing subject. Besides, the commodity identifier registered in the target commodity list 27b may also be another commodity identifier such as a commodity name but is not limited to a commodity code.

The program executed by the code reading apparatus 2 in the aforementioned embodiment is provided after being incorporated in the ROM and the like. The program executed by the code reading apparatus 2 in the aforementioned embodiment may also be recorded in a computer-readable recording medium such as CD-ROM, flexible disk (FD), CD-R, DVD (Digital Versatile Disk) and the like in the form of installable or executable file.

The program executed by the code reading apparatus 2 in the aforementioned embodiment may be stored in a computer connected with a network such as internet, and downloaded via the network. Further, the program executed by the code reading apparatus 2 in the aforementioned embodiment may also be provided or distributed via a network such as the Internet.

The program executed by the code reading apparatus 2 in the aforementioned embodiments consists of modules including all the aforementioned sections (image acquisition section 51, barcode detection section 52, target commodity determination section 53, flag information detection section 54, service information detection section 55, notification section 56, information output section 57), and as a piece of actual hardware, each of the aforementioned sections is downloaded to a primary storage device, and the image acquisition section 51, the barcode detection section 52, the target commodity determination section 53, the flag information detection section 54, the service information detection section 55, the notification section 56 and the information output section 57 are generated on the primary storage device by reading and executing the program from the ROM by a CPU (processor).

What is claimed is:

1. An information processing apparatus, comprising:
an image capturing unit configured to capture an image of a commodity;
a specification unit configured to specify the commodity from the information contained in the image captured by the image capturing unit;
a first detection unit configured to detect flag information from the captured image; and
a second detection unit configured to detect service information from the captured image if the flag information is detected by the first detection unit; wherein
the first detection unit switches flag information detection according to the commodity specified by the specification unit.

2. The information processing apparatus according to claim 1, further comprising:
a determination unit configured to determine, based on a list of commodities having a pattern similar to the flag information, whether or not the commodity specified by the specification unit is contained in the list; wherein
the second detection unit switches flag information detection according to the determination result of the specification unit.

3. The information processing apparatus according to claim 2, wherein
if the determination unit determines that the commodity code is registered in the list, the second detection unit detects the flag information using a detection which is stricter, in conditions of detecting the flag information, than the detection for detecting the commodities not registered in the list.

4. The information processing apparatus according to claim 1, wherein
the specification unit detects a code symbol from the captured image and specifies the commodity based on the code symbol.

5. The information processing apparatus according to claim 1, wherein
the specification unit extracts the feature amount of the commodity contained in the captured image and specifies the commodity based on the feature amount.

6. An information processing method, including:
specifying a commodity from the information contained in an image captured by an image capturing unit;
detecting flag information from the captured image; and
detecting service information from the captured image if the flag information is detected; wherein
the flag information detection method are switched according to the specified commodity.

7. The information processing method according to claim 6, further including:
determining, based on a list of commodities having a pattern similar to the flag information, whether or not the specified commodity is registered in the list, wherein
the flag information detection method are switched according to the determination result.

8. The information processing method according to claim 7, wherein
if it is determined that the commodity code is registered in the list, the flag information is detected using a detection method which is stricter, in conditions of detecting the flag information, than the detection method for detecting the commodities not registered in the list.

9. The information processing method according to claim 6, wherein
a code symbol is detected from the captured image, and the commodity is specified based on the code symbol.

10. The information processing method according to claim 6, wherein
the feature amount of the commodity contained in the captured image is extracted, and the commodity is specified based on the feature amount.
